(19) United States
(12) Patent Application Publication
(10) Pub. No.: US 2022/0074755 A1
(43) Pub. Date: Mar. 10, 2022

(54) INFORMATION PROCESSING SYSTEM, INFORMATION PROCESSING METHOD, AND STORAGE MEDIUM

(71) Applicant: HONDA MOTOR CO., LTD., Tokyo (JP)

(72) Inventors: Makoto Nagai, Tokyo (JP); Yo Ito, Tokyo (JP)

(21) Appl. No.: 17/465,920

(22) Filed: Sep. 3, 2021

(30) Foreign Application Priority Data
Sep. 7, 2020 (JP) 2020-149772

(51) Int. Cl. G01C 21/36; G01C 21/34

(52) U.S. Cl. CPC G01C 21/3617; G01C 21/3492; G01C 21/3484

(57) ABSTRACT

An information processing system includes an acquirer configured to acquire user information on a plurality of users via respective user terminals used by the plurality of users, a classifier configured to classify the plurality of users into one or more groups on the basis of the user information, a condition setter configured to set provision conditions of a movement device for users of each group based on group information of each group including user information of users classified into each group, and a determiner configured to determine a provision method of a movement device for users of each group on the basis of the provision conditions of a movement device set for each group.

### CROSS-REFERENCE TO RELATED APPLICATION

This application is based upon and claims the benefit of priority from Japanese Patent Application No. 2020-149772, filed Sep. 7, 2020, the entire content of which is incorporated herein by reference.

### BACKGROUND

### Field of the Invention

The present invention relates to an information processing system, an information processing method, and a storage medium.

### Description of Related Art

Conventionally, for example, a technology for providing guidance on a route from a start point to a destination according to a movement device used by a user (for example, refer to Japanese Unexamined Patent Application, First Publication No. 2020-112565) is known as a technology for supporting the movement of the user.

### SUMMARY

However, with the conventional technology, it may not always be possible to efficiently provide a movement device to a plurality of users.

The present invention has been made in consideration of such circumstances, and an object thereof is to provide an information processing system, an information processing method, and a storage medium that can efficiently provide a movement device to a plurality of users.

The information processing system, the information processing method, and the storage medium according to this invention have adopted the following configuration.

(1) According to a first aspect of the present invention, an information processing system includes an acquirer configured to acquire user information on a plurality of users via respective user terminals used by the plurality of users, a classifier configured to classify the plurality of users into one or more groups on the basis of the user information, a condition setter configured to set provision conditions of a movement device for users of each group based on group information of each group including user information of users classified into each group, and a determiner configured to determine a provision method of a movement device for users of each group on the basis of the provision conditions of a movement device set for each group.

(2) According to a second aspect of the present invention, in the first aspect, the determiner transmits identification information of the movement device that has determined a provision method to a user terminal used by a user of the movement device.

(3) According to a third aspect of the present invention, in the first or the second aspect, the movement device is a moving body capable of accommodating a user therein, the information processing system further includes a request processor configured to receive a provision request of a service that is available in the moving body, and an authenticator configured to execute authentication processing of the user, and the request processor receives the provision request of the service when a user who has requested provision of the service is authenticated by the authentication processing.

(4) According to a fourth aspect of the present invention, in the third aspect, the determiner assigns common identification information to movement devices of the group and users classified into the group, and when the movement devices and user terminals of users to which identification information common to the movement devices is assigned are close to each other within a predetermined range, the authenticator authenticates the users.

(5) According to a fifth aspect of the present invention, in the third or fourth aspect, the authenticator authenticates a user who has requested provision of the service when the user is registered as a user of the moving body.

(6) According to a sixth aspect of the present invention, in any one of the third to fifth aspects, the information processing system further includes an operation controller configured to control an operation of the moving body on the basis of positional information of the user.

(7) According to a seventh aspect of the present invention, in any one of the third to sixth aspects, the information processing system further includes a first device having the classifier, and a second device having the condition setter, and the first device further includes a provider that provides user information of users classified into the group from which at least personal information of the users is excluded to the second device as the group information.

(8) According to an eighth aspect of the present invention, the provider provides user information of the users to another device when the users are authenticated by the authenticator.

(9) According to a ninth aspect of the present invention, in any one of the third to eighth aspects, the request processor executes processing related to settlement of a usage charge for use of the service by the authenticated users on the basis of identification information of the users included in the user information.

(10) According to a tenth aspect of the present invention, an information processing method includes, by a computer, acquiring user information on a plurality of users via respective user terminals used by the plurality of users, classifying the plurality of users into one or more groups on the basis of the user information, setting provision conditions of a movement device for users of each group based on group information of each group including user information of users classified into each group, and determining a provision method of a movement device for users of each group on the basis of the provision conditions of a movement device set for each group.

(11) According to an eleventh aspect of the present invention, a computer-readable non-transitory storage medium stores a program for causing a computer to execute acquiring user information on a plurality of users via respective user terminals used by the plurality of users, classifying the plurality of users into one or more groups on the basis of the user information, setting provision conditions of a movement device for users of each group based on group information of each group including user information of users classified into each group, and determining a provision method of a movement device for users of each group on the basis of the provision conditions of a movement device set for each group.

According to the aspects described above, it is possible to efficiently provide movement devices to a plurality of users by acquiring user information on a plurality of users via respective user terminals used by the plurality of users, classifying the plurality of users into one or more groups on the basis of the user information, setting provision conditions of a movement device for users of each group based on group information of each group including user information of users classified into each group, and determining a provision method of a movement device for users of each group on the basis of the provision conditions of a movement device set for each group.

### BRIEF DESCRIPTION OF THE DRAWINGS

FIG. 1 is a diagram which shows an outline of a movement service providing system in an embodiment.

FIG. 2 is a diagram which shows an example of a system configuration of the movement service providing system in the embodiment.

FIG. 3 is a diagram which shows an example of user management information in the embodiment.

FIG. 4 is a diagram which shows an example of group information in the embodiment.

FIG. 5 is a first flowchart which shows an example of processing in which the movement service providing system of the embodiment provides a movement device to a user.

FIG. 6 is a second flowchart which shows an example of the processing in which the movement service providing system of the embodiment provides a movement device to a user.

FIG. 7 is a flowchart which shows an example of processing in which the movement service providing system of the embodiment provides an additional service to a user of a movement device.

### DESCRIPTION OF EMBODIMENTS

Hereinafter, embodiments of an information processing system, an information processing method, and a storage medium of the present invention will be described with reference to the drawings. In the following description, one “movement” means starting from a certain start point and reaching a certain destination. In addition, a “movement method” in the following description includes at least a route from the start point to the destination (hereinafter, referred to as a “movement route”), and may include a device that moves along a path of the movement route (hereinafter, referred to as a “movement device”) and a timing at which the movement is performed (hereinafter, referred to as a “movement timing”).

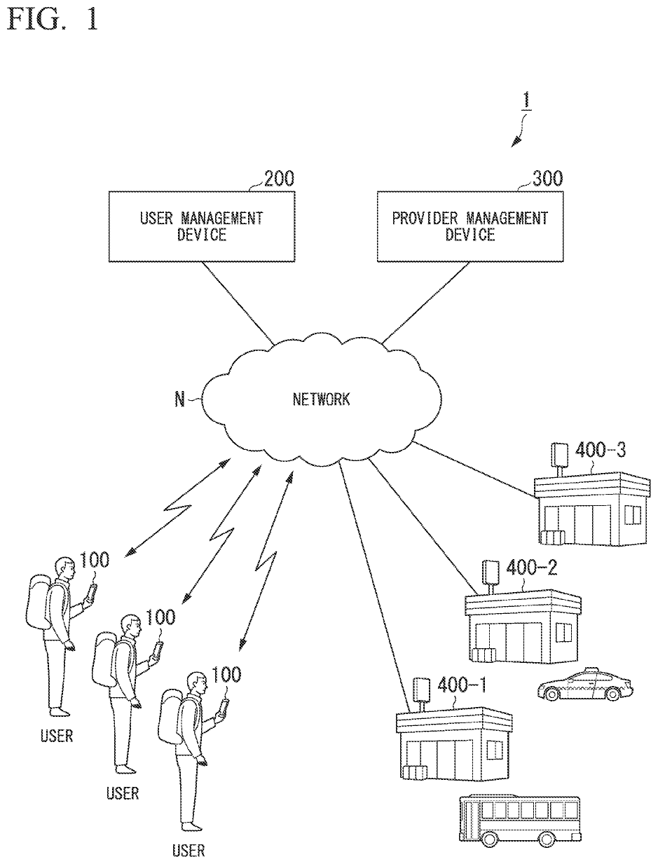

FIG. 1 is a diagram which shows an outline of a movement service providing system 1 in the present embodiment. The movement service providing system 1 is a system that provides a movement service to a user. Here, a “movement service” is a service that provides at least a movement device to a user, and includes a service provided incidentally when the movement device is used (hereinafter, referred to as an “additional service”). Specifically, the additional service is a service that the user can use while using a provided movement device. For example, a movement device provided to a user is a moving body such as a vehicle or an aircraft in which a user can be accommodated. An additional service is a service that can be used in a moving body provided as a movement device when a user is accommodated in the moving body. For example, the additional service may be a service that sells goods in the moving body, or may be an information processing service that can be used only in the moving body.

In order to provide such a movement service, the movement service providing system 1 of the embodiment includes a user terminal 100 used by a user, a user management device 200, a provider management device 300, and a service provider 400 that is a provider of a movement service. The user terminal 100, the user management device 200, the provider management device 300, and the service provider 400 are communicably connected to each other via a network N.

The user terminal 100 is a terminal device used by a user to use the movement service providing system 1. For example, the user terminal 100 is a portable wireless communication terminal such as a smartphone or tablet, and is connected to the network N via a wireless communication line such as a cellular network. For example, an application (hereinafter, referred to as a “service app”) that provides a movement service to a user in cooperation with the user management device 200 is installed in the user terminal 100. For example, the service app receives an input of information regarding a movement of a user who uses the movement service providing system 1 (hereinafter, referred to as “user information”), and transmits the input user information to the user management device 200. Moreover, the user terminal 100 receives information regarding a movement service (hereinafter, referred to as “service information”) from the user management device 200, and notifies the user of the received service information. For example, the service information includes identification information of a movement device provided to the user and contents of an additional service that can be used together with the movement device. According to the service information provided in this manner, the user can identify an available movement device and ascertain an additional service available together with the movement device.

The user management device 200 and the provider management device 300 are devices that determine movement devices to be provided to a plurality of users and a provision method thereof by linking various types of information between the user terminal 100 and the service provider 400. Specifically, the user management device 200 acquires user information of each user from user terminals 100 of a plurality of users who use the movement service providing system 1, and generates user management information (hereinafter, referred to as “user management information”) on the basis of the acquired user information.

The provider management device 300 acquires information regarding the service provider 400 (hereinafter, referred to as “provider information”) capable of providing a movement service to users of the movement service providing system 1 from the service provider 400, and generates management information of each service provider 400 (hereinafter, referred to as “provider management information”) on the basis of the acquired provider information. Moreover, the provider management device 300 has a function of determining movement devices to be provided to the plurality of users and provision conditions thereof on the basis of the user information of the plurality of users provided by the user management device 200 and the provider information managed by itself, and notifying a related service provider 400 of the determined devices and conditions. For example, the provider management device 300 acquires user information including movement schedules of the plurality of users, selects a movement device capable of efficiently (for example, by minimizing costs to both users and the service provider 400 as much as possible) realizing movements of the plurality of users as a whole, and determines a movement route of the movement device as a provision condition.

The service provider 400 is a business operator that provides movement services to users of the movement service providing system 1. For example, the service provider 400 that provides a movement device (for example, service providers 400-1 and 400-2 in the drawing) determines a specific provision method of a movement device on the basis of a movement device notified of by the provider management device 300 and the provision conditions thereof, and provides the movement device to users on the basis of the determined provision method. Moreover, for example, the service provider 400 that provides an additional service (for example, a service provider 400-3 in the drawing) provides an additional service according to a movement device to the users of the movement device notified of by the provider management device 300. The service provider 400 links various types of information with the provider management device 300 regarding the provision of such a movement service.

With such a configuration, the movement service providing system 1 can optimize the provision method of a movement device for a plurality of users. For this reason, according to the movement service providing system 1 of the embodiment, the service provider 400 can efficiently use resources required for providing a service, and can reduce unnecessary cost. Furthermore, according to the movement service providing system 1 of the embodiment, since the movement device and the provision method can be flexibly changed according to the movement schedule of a user, convenience of the movement device can be improved. Hereinafter, a configuration of the movement service providing system 1 that exerts such an effect will be described in detail as follows.

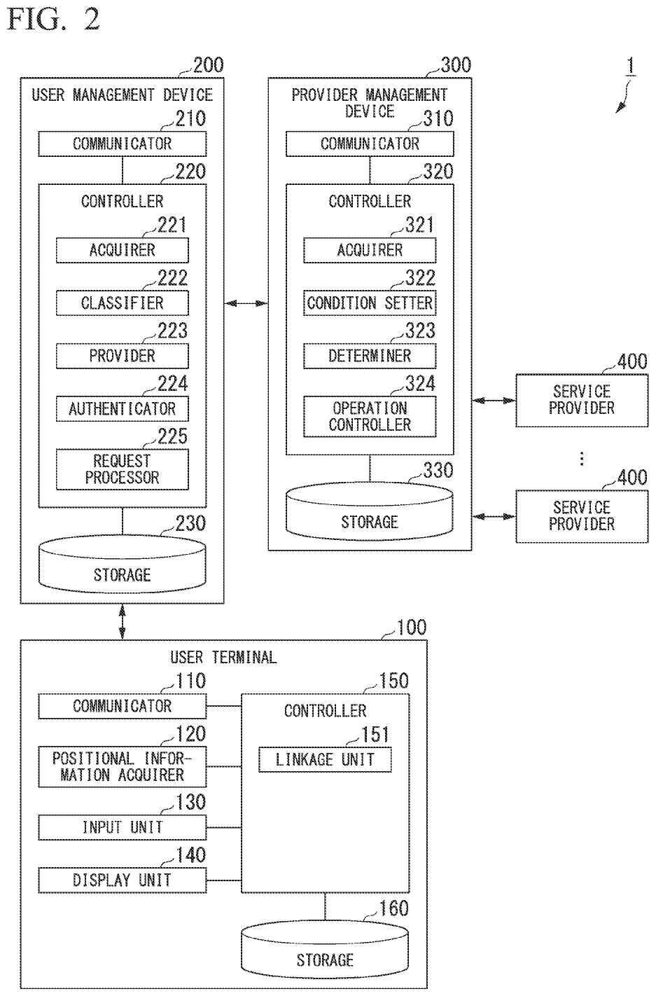

FIG. 2 is a diagram which shows an example of a system configuration of the movement service providing system 1 in the present embodiment. For example, the user terminal 100 includes a communicator 110, a positional information acquirer 120, an input unit 130, a display unit 140, a controller 150, and a storage 160. These components are realized by, for example, a hardware processor such as a central processing unit (CPU) executing a program (software). Some or all of these components may be realized by hardware (a circuit unit; including circuitry) such as large-scale integration (LSI), an application specific integrated circuit (ASIC), a field-programmable gate array (FPGA), or a graphics processing unit (GPU), or may be realized by software and hardware in cooperation. The program may be stored in advance in a storage device (a storage device having a non-transitory storage medium) such as a hard disk drive (HDD) or a flash memory, or may also be stored in a detachable storage device (a non-transitory storage medium) such as a DVD or a CD-ROM and installed by the storage medium being mounted in a drive device.

The communicator 110 is a wireless communication interface for connecting the user terminal 100 to the network N. For example, the communicator 110 wirelessly connects to a base station such as a cellular network, and connects to the network N via the base station. The communicator 110 communicates with the user management device 200 via the network N. The communicator 110 may also have a short-range wireless communication function such as near field communication (NFC) in addition to such a wide area wireless communication function.

The positional information acquirer 120 acquires positional information of the user terminal 100. The positional information acquirer 120 is, for example, a Global Positioning System (GPS) sensor. The positional information acquirer 120 outputs the acquired positional information to the controller 150.

The input unit 130 is configured by using, for example, input devices such as a keyboard, a mouse, and a touch panel. The input unit 130 receives inputs for various operations to the user terminal 100. The input unit 130 outputs the input information to the controller 150.

The display unit 140 is configured by using, for example, a display device such as a liquid crystal display, or an organic electro-luminescence (EL) display. The display unit 140 displays various types of information output from the controller 150. The display unit 140 may be integrated with the input unit 130 using a touch panel.

The controller 150 controls an operation of the user terminal 100. Specifically, the controller 150 includes a linkage unit 151 that realizes a linkage function with the user management device 200 in addition to having a function of controlling an input or output among the communicator 110, the positional information acquirer 120, the input unit 130, the display unit 140, and the storage 160. The linkage unit 151 is realized by, for example, executing the service app.

Specifically, the linkage unit 151 transmits information necessary for receiving a provision of a movement service from the movement service providing system 1 to the user management device 200 as user information. For example, the linkage unit 151 transmits the positional information of the user terminal 100 acquired by the positional information acquirer 120, or information such as a movement device, movement conditions, a start point, a destination, and a movement time, which is input to the user terminal 100 by a user with respect to his or her movement as user information. In addition, on the other hand, the linkage unit 151 has a function of acquiring service information on a determined movement device from the user management device 200 and notifying a user of the information. For example, the linkage unit 151 causes the display unit 140 to display the contents of the acquired service information.

The storage 160 is configured by using, for example, a magnetic storage device such as a hard disk drive (HDD) or a semiconductor storage device such as a solid-state drive (SSD). The storage 160 stores various types of information related to the operation of the user terminal 100. For example, a program of the service app is stored in the storage 160. Moreover, for example, the storage 160 may store the positional information acquired by the positional information acquirer 120, the service information acquired from the user management device 200, and the like.

Next, the configuration of the user management device 200 will be described. The user management device 200 includes a communicator 210, a controller 220, and a storage 230. These components are realized by, for example, a hardware processor such as a CPU executing a program (software). Some or all of these components may be realized by hardware (a circuit unit; including circuitry) such as LSI, an ASIC, an FPGA, or a GPU, or may be realized by software and hardware in cooperation. The program may be stored in advance in a storage device (a storage device having a non-transitory storage medium) such as an HDD or a flash memory, or may also be stored in a detachable storage medium (a non-transitory storage medium) such as a DVD or a CD-ROM and installed by the storage medium being mounted in a drive device.

The communicator 210 is a communication interface for connecting the user management device 200 to the network N. The communicator 210 may be a wireless communication interface or a wired communication interface. The communicator 210 communicates with the user terminal 100 and the provider management device 300 via the network N.

The controller 220 controls an operation of the user management device 200. Specifically, the controller 220 has a function of controlling an input or output between the communicator 210 and the storage 230, and also includes an acquirer 221, a classifier 222, a provider 223, an authenticator 224, and a request processor 225 as constituents for realizing a function of linking between the user terminal 100 and the provider management device 300.

The acquirer 221 has a function of acquiring information from the user terminal 100 and the provider management device 300. For example, the acquirer 221 acquires user information from the user terminal 100. The acquirer 221 generates user management information on the basis of the acquired user information, and records the generated user management information in the storage 230. When the user management information is already recorded in the storage 230, the acquirer 221 may update existing user management information on the basis of the acquired user information. Moreover, for example, the acquirer 221 acquires service information from the provider management device 300, and records the acquired service information in the storage 230.

The classifier 222 has a function of classifying a plurality of users into a group of users (hereinafter, referred to as a “service group”) to whom the same movement device is provided on the basis of the movement schedule of the plurality of users. Specifically, the classifier 222 classifies users with similar movement methods into the same service group. For example, the classifier 222 may classify users who have movement schedules to move within a predetermined range into the same service group, classify users who have movement schedules to move within a predetermined time period into the same service group, or classify users who desire the same movement device into the same service group. The classifier 222 records in the storage 230 correspondence between each service group classified in this manner and users classified into each service group.

The provider 223 has a function of providing user information or group information to the user terminal 100 and the provider management device 300. Specifically, the provider 223 provides the provider management device 300 with the user information of users classified into each service group as the group information of each service group. Furthermore, the provider 223 provides the user information of a target user to whom a movement service is provided (hereinafter, referred to as a “target user”) to the service provider 400 which provides the target user with the movement service.

Here, when the user information or the group information is provided to the provider management device 300, the provider 223 excludes (or masks) information that can specify a target user (hereinafter, referred to as “personal information”) from the user information of each user, and then provides a result to the provider management device 300. This is, for example, when an operating entity of the user management device 200 and an operating entity of the provider management device 300 are different, because it is not preferable from a viewpoint of security to provide the personal information of the target user to another operating entity in a situation where it is not confirmed that the target user will use a movement device, or the probability is low.

On the other hand, in a situation wherein is confirmed that the target user will use a movement device or the probability is high, the personal information of the target user may be required in the provider management device 300 or the service provider 400 for settlement processing for a usage charge of the movement service used by the target user, provision of a movement service to the target user, and the like. For this reason, the provider 223 can provide the user information to the provider management device 300 without excluding the personal information of the target user in situations where an external provision of user information is permitted for the target user, such as in a situation where it is confirmed that the target user will use a movement service.

The authenticator 224 has a function of authenticating a user. For example, the authenticator 224 may acquire authentication information such as an ID and a password from the user terminal 100 to authenticate a user, or may use the information such as a digital certificate stored in the user terminal 100 to authenticate a user. In addition, for example, the authenticator 224 may authenticate a target user when the user terminal 100 of the target user is close to a movement device provided to the target user. In this case, for example, the determiner 323 generates identification information common to a movement device that has determined a provision method and a user of the movement device and transmits the identification information to the user terminal 100 and the movement device (or its service provider 400), and thereby the authenticator 224 can identify correspondence between the user terminal 100 and the movement device on the basis of the common identification information acquired from them.

For example, user authentication using the authenticator 224 is performed when a target user starts using a provided movement device, or when a target user requests provision of an additional service while using the movement device. That is, in other words, it can be said that the provider 223 described above excludes (or masks) the personal information of a target user from the user information and provides a result to the provider management device 300 when the target user has not been authenticated, and the provider 223 provides the user information to the provider management device 300 without excluding the personal information when a target user has already been authenticated.

The request processor 225 has a function of processing a request for providing an additional service by a user of a movement device. For example, when a user who has requested the provision of an additional service is registered as the user of a movement device associated with the additional service, the request processor 225 receives the request of the user. When the request processor 225 receives the request for providing the additional service by the user, the request processor 225 notifies the service provider 400 that is a request destination of the request via the provider management device 300. In response to this notification, each service provider 400 provides an additional service.

Next, a configuration of the provider management device 300 will be described. The provider management device 300 includes a communicator 310, a controller 320, and a storage 330. These components are realized by, for example, a hardware processor such as a CPU executing a program (software). Some or all of these components may be realized by hardware (a circuit unit; including circuitry) such as LSI, ASIC, FPGA, GPU, or may be realized by software and hardware in cooperation. The program may be stored in advance in a storage device such as an HDD or a flash memory (a storage device including a non-transitory storage medium), or a removable storage medium such as a DVD or a CD-ROM (a non-transitory storage medium), and may be installed by the storage medium being mounted in a drive device.

The communicator 310 is a communication interface for connecting the provider management device 300 to the network N. The communicator 310 may be a wireless communication interface or a wired communication interface. The communicator 310 communicates with the user management device 200 and the service provider 400 via the network N.

The controller 320 controls an operation of the provider management device 300. Specifically, the controller 320 has a function of controlling an input or output between the communicator 310 and the storage 330, and also includes an acquirer 321, a condition setter 322, a determiner 323, and an operation controller 324 as constituents for realizing a function of linking with the user management device 200 and each service provider 400.

The acquirer 321 has a function of acquiring group information or user information from the provider 223 of the user management device 200. The acquirer 321 records the acquired group information and user information in the storage 330.

The condition setter 322 sets the provision conditions of a movement device provided to the users of each service group on the basis of the group information acquired by the acquirer 321. Specifically, the condition setter 322 determines a movement device that can efficiently realize the movement of the users of each service group as a whole based on the user information included in the group information, and also determines a movement route and a movement timing of the movement device as the provision method of the movement device.

For example, the condition setter 322 may determine a movement route that minimizes a movement cost of a user as a provision condition, or may also determine a movement route that minimizes a service provision cost of the service provider 400 as a provision condition. The movement cost of a user may be calculated on the basis of an expense required for a movement, or may also be calculated on the basis of a time required for a movement. Moreover, the provision conditions of a movement device may include a constraint condition to be satisfied at the time of movement on the movement route, in addition to the movement route and the movement timing. For example, the provision conditions of the movement device may include a limit on a charge required for a movement in a predetermined section on a movement route, a limit on a required time, and the like. In addition, the condition setter 322 may include a necessary condition for each user to use a movement device in the provision conditions of a movement device as a constraint condition.

The determiner 323 determines the provision method of a movement device provided to the users of each service group on the basis of the provision conditions of a movement device set in each service group. For example, the determiner 323 determines a movement device and its provision method (for example, an operation plan of the movement device, or the like) so that the set provision conditions of a movement device are satisfied for each service group. The determiner 323 generates service information for notifying the users classified into each service group of the provision method of a movement device determined in this manner, and provides it to the user management device 200. The service information is notified of to a target user terminal 100 by the user management device 200. On the other hand, the determiner 323 notifies the operation controller 324 of the determined provision method of a movement device.

The operation controller 324 has a function of controlling the operation of a movement device provided by each service provider 400 on the basis of the provision method of a movement device determined by the determiner 323. For example, the operation controller 324 may control a movement device such that it waits for a specific user to board at a bus stop, or may control a movement device such that it does not stop at a bus stop where there are no more users to board as a result of receiving suspension of use from a user. Moreover, the operation controller 324 may be configured to control the operation of a movement device under preset conditions other than the provision conditions determined by the determiner 323.

For example, it is assumed that the movement service providing system 1 is applied to transportation of employees of a company. In this case, it is assumed that the user management device 200 is run by a company that employs employees who are users. In this case, if an administrator of a company registers operation conditions of a movement device in the user management device 200 in advance, the operation controller 324 is configured to acquire setting information of the operation conditions from the user management device 200 when the provision of a movement device is started, and to control the operation of the movement device on the basis of the acquired setting information.

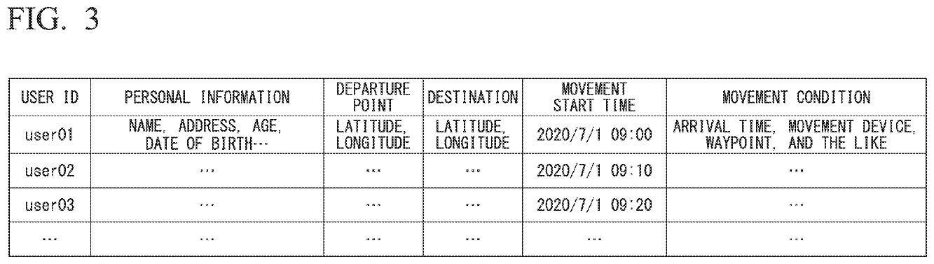

FIG. 3 is a diagram which shows an example of the user management information in the present embodiment. For example, the user management information is recorded in the storage 230 in a mode of a user management table T1 shown in FIG. 3. The user management table T1 has values of a user ID, personal information, a departure point, a destination, a movement start time, and a movement condition. A user ID is identification information of each user. Personal information is information such as an address, a name, an age, and a date of birth that can identify each user. A departure point represents a departure point of a movement planned by a user, and a destination represents a destination of the movement. A movement start time is a time at which a user is scheduled to start the movement from a departure point to a destination, and a movement condition represents a condition to be realized in a scheduled movement.

In this user management table T1, for example, personal information, a departure point, a destination, a movement start time, and a movement condition are acquired from the user terminal 100 of each user as user information. In this case, the acquirer 221 generates the user management table T1 by associating the user ID of each user with user information acquired from each user terminal 100, and records the generated user management table in the storage 230.

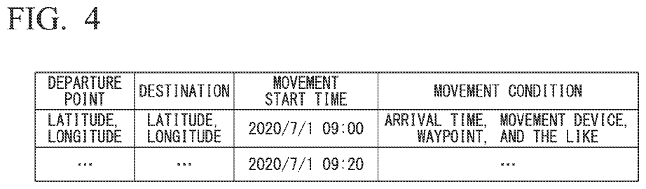

In addition, in this case, the provider 223 extracts a record of users belonging to a target service group from the user management table T1, and provides information excluding values of personal information, a user ID, and the like that can specify a user among the values included in the extracted record to the provider management device 300 as group information. For example, FIG. 4 is a diagram which shows an example of the group information in the present embodiment. A group information table T2 shown in FIG. 4 is an example of group information linked for a service group including users identified by user IDs “user01” and “user03” shown in FIG. 3.

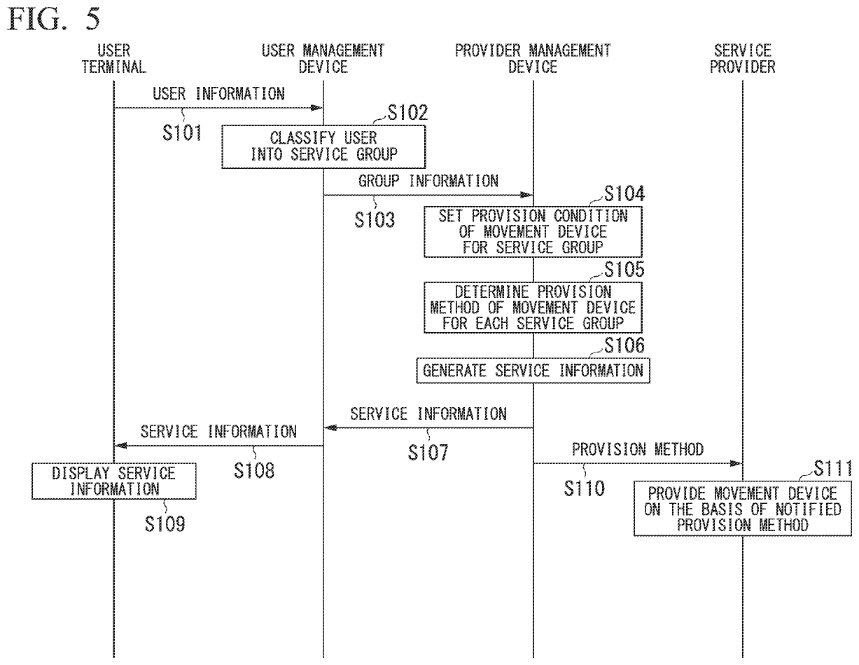

FIG. 5 is a first flowchart which shows an example of processing in which the movement service providing system 1 of the present embodiment provides a movement device to a user. First, in the user terminal 100, the linkage unit 151 transmits user information including the movement schedule of a user to the user management device 200 (step S101). Here, it is assumed that the user information is registered in the user terminal 100 by a user in advance. For example, the user information may be schedule information in which the movement schedule of a user is input. The transmitted user information is received by the user management device 200 and managed as user management information by the acquirer 221.

Subsequently, in the user management device 200, the classifier 222 classifies a plurality of users into a service group that proposes the same movement device on the basis of the movement schedules of the plurality of users (step S102). Subsequently, the provider 223 generates the group information of each service group and transmits the generated group information to the provider management device 300 (step S103). The group information is received by the provider management device 300.

Subsequently, in the provider management device 300, the condition setter 322 sets the provision conditions of a movement device to be provided to each service group on the basis of the group information of each service group acquired from the user management device 200 (step S104). Specifically, the condition setter 322 sets at least a movement route that can realize the movement of users belonging to each service group as a provision condition.

Next, the determiner 323 determines a provision method of a movement device provided to the users of each service group on the basis of the provision conditions of a movement device set for each service group by the condition setter 322 (step S105). For example, the determiner 323 determines a movement device and an operation plan that satisfy the provision conditions of the set movement device as the provision method of the movement device for each service group. The determiner 323 generates service information for notifying the users of each service group of the determined provision method of a movement device (step S106), and transmits the generated service information to the user management device 200 (step S107). The transmitted service information is relayed to the user terminal 100 by the user management device 200 (step S108). In the user terminal 100, the linkage unit 151 causes the display unit 140 to display the received service information (step S109).

On the other hand, in the provider management device 300, the determiner 323 notifies the service provider 400 that provides a movement device determined in step S105 of a provision method determined for the movement device (step S110). The service provider 400 provides the movement device to a user on the basis of the notified provision method (step S111). The service provider 400 that provides the movement device may be configured to provide the movement device to an authenticated user. For example, the authentication of a user may be performed by the service provider 400 acquiring authentication information from the user terminal 100 of a target user via a device such as a camera or a short-range wireless communication device provided in the movement device, and verifying the acquired authentication information. Moreover, for example, the authentication of a user may also be performed by the authenticator 224 of the user management device 200. For example, the authenticator 224 may acquire the identification information of a target user as the user information from the user terminal 100, and when a user identified by the identification information is registered as the user of a movement device, the authenticator may authenticate the user. Furthermore, for example, when the authenticator 224 may acquire positional information of the user terminal 100 of a target user as the user information and authenticate the user when it is determined that the user terminal 100 is positioned within a predetermined range from the movement device on the basis of the positional information. Furthermore, for example, the authenticator 224 may authenticate a user by combining a plurality of these authentication methods.

An operation control of a movement device may be performed by the service provider 400 that provides a movement device, or may be performed by the operation controller 324 of the provider management device 300. When the provider management device 300 controls the operation of a movement device, the determiner 323 notifies the operation controller 324 of a provision method determined for each movement device. The operation controller 324 may control the operation of a movement device on the basis of the notified provision method, or may modify the operation control performed by the service provider 400. Moreover, the operation controller 324 may directly instruct a movement device to operate, or may instruct the service provider 400 of the movement device to operate.

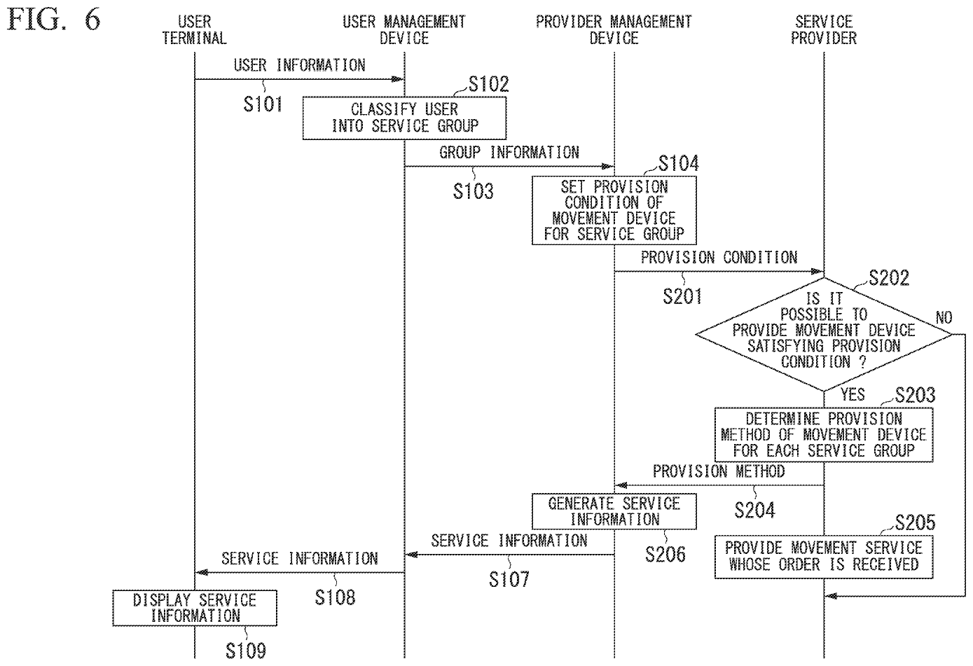

FIG. 6 is a second flowchart which shows an example of processing in which the movement service providing system 1 of the present embodiment provides a movement device to a user. While the provider management device 300 determines the provision method of a movement device of each service group and notifies a related service provider 400 of the provision method in the first flowchart, the second flowchart differs from the first flowchart in that the service provider 400 that can satisfy the provision conditions of a movement device receives an order for a service of providing a movement device and determines the provision method of the service. The first flowchart and the second flowchart have pieces of common processing except for processing related to this difference. For this reason, these pieces of common processing in FIG. 6 are denoted by the same reference numerals as those in FIG. 5, and the description thereof will be omitted herein.

When the provision conditions for a movement device are set for each service group in step S104, the condition setter 322 notifies each service provider 400 of information indicating the provision conditions set for each service group (step S201). Each service provider 400 determines whether a movement device satisfying the notified provision conditions can be provided (step S202). Here, when it is determined that a movement device satisfying the notified provision conditions can be provided, the service provider 400 determines the provision method of a movement device satisfying the notified provision conditions for each service group (step S203).

The service provider 400 notifies the provider management device 300 that an order for the provision service of a movement device can be received by notifying the provider management device 300 of the determined provision method of a movement device (step S204). The provider management device 300 that has received this notification that an order can be received confirms the order for a movement device to the service provider 400 that has transmitted the notification that an order can be received, and notifies the service provider 400 of that effect. When a notification of the order confirmation is given, the service provider 400 provides each movement device in the provision method determined in step S203 (step S205). On the other hand, in step S202, when it is determined that a movement device satisfying the notified provision conditions cannot be provided, the service provider 400 does not transmit the notification that an order can be received for the service providing a movement device.

In addition, in the provider management device 300, the condition setter 322 generates service information based on a provision method notified of by the service provider 400 in step S204 (step S206), and transmits the generated service information to the user management device 200 (step S107).

Here, when the provision methods of a movement device are notified of by a plurality of service providers 400, the condition setter 322 may compare between the provision methods and select one of the service providers 400. For example, the condition setter 322 may select a service provider 400 that has notified a movement method with the minimum usage cost, or may select a service provider 400 that has notified a movement method with the shortest movement time.

In addition, the condition setter 322 may adopt a provision method of a service provider 400, which is different for each section constituting a part of a movement route. In this case, when provision conditions in any section constituting the movement route can be satisfied, each service provider 400 may determine the provision method of a movement device in the section and notify the provider management device 300 of the determined provision method.

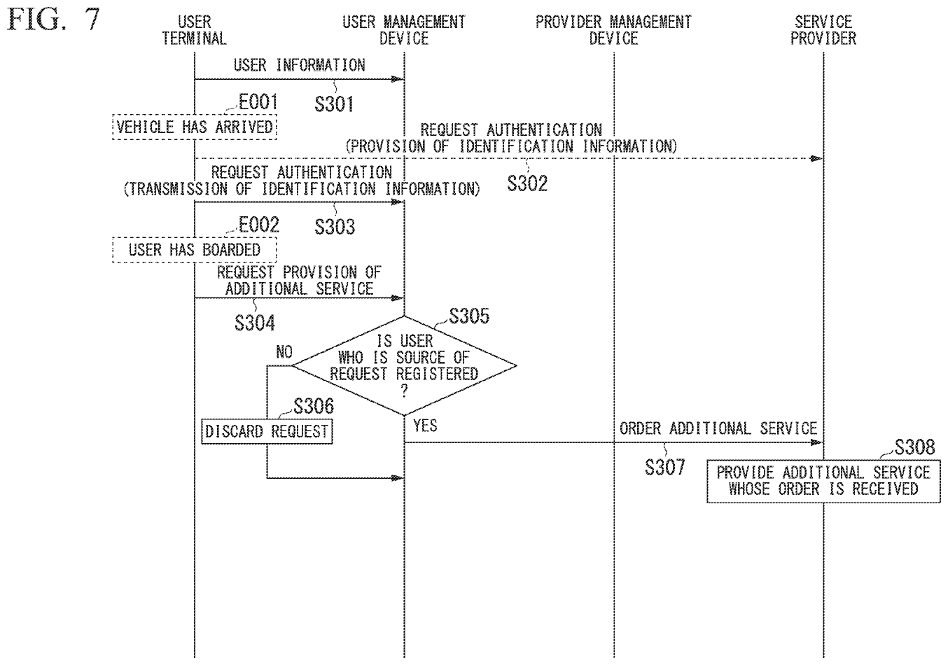

FIG. 7 is a flowchart which shows an example of processing in which the movement service providing system 1 of the present embodiment provides an additional service to the user of a movement device. First, in the user terminal 100, the linkage unit 151 acquires the positional information of the user terminal 100 from the positional information acquirer 120, and transmits user information including the acquired positional information to the user management device 200 (step S301). Note that it is assumed that the transmission of the user information including this positional information is performed periodically during execution of this flowchart.

Here, it is assumed that a user is waiting at a provision place of a movement device to use a movement device provided by the service provider 400. For example, when the movement device is a vehicle, a stop place of the vehicle and a scheduled time of arrival at the stop place are notified of to a user in advance according to service information. In this case, the user is waiting for the arrival of the vehicle at the stop place at the notified scheduled time of arrival. When the vehicle arrives at the stop place in this situation (event E001), the user starts using the movement device by boarding the arriving vehicle. In this case, for example, the user can start using the movement device when it is authenticated that the user is the user of the movement device. For example, here, it is assumed that the service provider 400 that provides a vehicle and the user management device 200 that has determined a provision method of the vehicle perform user authentication.

For example, the user terminal 100 requests the service provider 400 for the user authentication by providing the identification information of users to the service provider 400 in cooperation with an authentication device (not shown) mounted in the vehicle (step S302). For example, when the authentication device is an information reading device equipped with a camera or the like, the user terminal 100 may cause the display unit 140 to display the identification information of users and cause the authentication device to read the displayed identification information. Moreover, for example, when the authentication device is a short-range wireless communication device, the user terminal 100 may transmit the identification information of users to the authentication device according to short-range wireless communication. In these cases, the identification information of users is provided to the service provider 400 via the authentication device. In the drawing, an arrow of step S302 is represented by a broken line, which means that the identification information of users is indirectly provided to the service provider via the authentication device.

In addition, for example, the user terminal 100 requests the user management device 200 for user authentication by transmitting the identification information of users to the user management device 200 (step S303). In this case, a user is permitted to board a vehicle when the user is authenticated by both the service provider 400 and the user management device 200. When a user is permitted to board a vehicle, the user can start using a movement service provided by the vehicle by boarding the vehicle (event E002).

When the provided vehicle is a vehicle that can provide an additional service inside the vehicle, a user can use the additional service while moving in the vehicle. In this case, for example, the user terminal 100 requests the user management device 200 to provide an additional service desired by a user according to the operation of the user (step S304). In the following description, a request of a user for the provision of an additional service using the user terminal 100 is also referred to as an “order of an additional service.” In the user management device 200, the request processor 225 receives the received provision request of an additional service, and determines whether a user who is a source of the request is registered as a user of a vehicle that provides the additional service (step S305). For example, when the service information relayed to the user terminal 100 is held in the user management device 200, the request processor 225 can determine whether the user who is the source of the request is registered as the user of the vehicle that provides the additional service on the basis of the service information held in the user management device 200. Moreover, for example, the request processor 225 may also inquire to the provider management device 300 whether the user who is the source of the request is registered as the user of the vehicle that provides the additional service.

Here, when the user who is the source of the request is not registered as the user of the vehicle that provides the additional service to be requested, the request processor 225 discards the provision request of the additional service (step S306). In this case, the request processor 225 may notify the user terminal 100 that the provision request of the additional service is not received. On the other hand, in step S305, when the user who is the source of the request is registered as the user of the vehicle that provides the additional service to be requested, the request processor 225 requests the service provider 400 to provide the additional service requested by the user (step S307). The service provider 400 that has received the request provides the additional service requested by the user (step S308).

The movement service providing system 1 of the embodiment configured in this manner classifies a plurality of users into one or more service groups, and determines a provision method of a movement device to be provided for each service group on the basis of the user information of the users classified into each service group, thereby efficiently providing a movement device to the plurality of users.

The embodiment described above can be expressed as follows.

An information processing system includes a storage device that stores a program, and a hardware processor, and is configured to, by the hardware processor executing the program stored in the storage device, acquire user information on a plurality of users via respective user terminals that are used by the plurality of users, classify the plurality of users into one or more groups on the basis of the user information, set provision conditions of a movement device for users of each group based on group information for each group, including user information of users classified into each group, and determine a provision method of a movement device for users of each group on the basis of the provision conditions of a movement device set for each group.

Although the embodiments for carrying out the present invention have been described above using the embodiments, the present invention is not limited to these embodiments, and various modifications and substitutions are made without departing from the gist of the present invention.

What is claimed is:

1. An information processing system comprising:
an acquirer configured to acquire user information on a plurality of users via respective user terminals used by the plurality of users;
a classifier configured to classify the plurality of users into one or more groups on the basis of the user information;
a condition setter configured to set provision conditions of a movement device for users of each group based on group information of each group including user information of users classified into each group; and
a determiner configured to determine a provision method of a movement device for users of each group on the basis of the provision conditions of a movement device set for each group.

2. The information processing system according to claim 1,
wherein the determiner transmits identification information of the movement device that has determined a provision method to a user terminal used by a user of the movement device.

3. The information processing system according to claim 1, further comprising:
wherein the movement device is a moving body capable of accommodating a user therein,
the information processing system further comprises:
a request processor configured to receive a provision request of a service that is available in the moving body; and
an authenticator configured to execute authentication processing of the user, and
the request processor receives the provision request of the service when a user who has requested a provision of the service is authenticated by the authentication processing.

4. The information processing system according to claim 3,
wherein the determiner assigns common identification information to movement devices of the group and users classified into the group, and
when the movement devices and user terminals of users to which identification information common to the movement devices is assigned are close to each other within a predetermined range, the authenticator authenticates the users.

5. The information processing system according to claim 3,
wherein the authenticator authenticates a user who has requested provision of the service when the user is registered as a user of the moving body.

6. The information processing system according to claim 3, further comprising:
an operation controller configured to control an operation of the moving body on the basis of positional information of the user.

7. The information processing system according to claim 3, further comprising:
a first device including the classifier; and
a second device including the condition setter,
wherein the first device further includes a provider that provides user information of users classified into the group from which at least personal information of the users is excluded to the second device as the group information.

8. The information processing system according to claim 7,
wherein the provider provides user information of the users to another device when the users are authenticated by the authenticator.

9. The information processing system according to claim 3,
wherein the request processor executes processing related to settlement of a usage charge for use of the service by the authenticated users on the basis of identification information of the users included in the user information.

10. An information processing method comprising:
by a computer,
acquiring user information on a plurality of users via respective user terminals used by the plurality of users;
classifying the plurality of users into one or more groups on the basis of the user information;
setting provision conditions of a movement device for users of each group based on group information of each group including user information of users classified into each group; and
determining a provision method of a movement device for users of each group on the basis of the provision conditions of a movement device set for each group.

11. A computer-readable non-transitory storage medium that stores a program for causing a computer to execute:
acquiring user information on a plurality of users via respective user terminals used by the plurality of users;
classifying the plurality of users into one or more groups on the basis of the user information;
setting provision conditions of a movement device for users of each group based on group information of each group including user information of users classified into each group; and
determining a provision method of a movement device for users of each group on the basis of the provision conditions of a movement device set for each group.
